(19) United States
(12) Patent Application Publication
(10) Pub. No.: US 2026/0043959 A1
(43) Pub. Date: Feb. 12, 2026

(54) FEW-MODE OPTICAL FIBER

(71) Applicant: STERLITE TECHNOLOGIES LIMITED, Gurugram (IN)

(72) Inventors: Pramod Ramdasrao Watekar, Gurugram (IN); Priya Ramanthan, Gurugram (IN)

(21) Appl. No.: 19/297,070

(22) Filed: Aug. 12, 2025

(30) Foreign Application Priority Data
Aug. 12, 2024 (IN) 202411062695

(51) Int. Cl. G02B 6/02

(52) U.S. Cl. CPC G02B 6/02319

(57) ABSTRACT

The present invention provides an optical fiber (100) (i.e., a few-mode optical fiber (100) comprising: at least three consecutive up-doped regions (i.e., core region) (102); and a cladding region (104) surrounding the at least three consecutive up-doped regions (102). In particular, the at least three consecutive regions (102) comprising a first up-doped region (106) having a first maximum refractive index (n1max), a second up-doped region (108) having a second maximum refractive index (n2max), and a third up-doped region (110) having a third maximum refractive index (n3max) where n2max>n3max>n1max. Further, the optical fiber (100) is constructed to allow only LP₀₁ mode of optical light and LP₁₁ mode of optical light to propagate through the few-mode optical fiber (100) and possesses high effective area and low Differential Mode Delay.

### CROSS-REFERENCE TO RELATED APPLICATIONS

The present application claims the benefit of Indian Application No. 202411062695 titled “FEW-MODE OPTICAL FIBER” filed by the applicant on Aug. 12, 2024, which is incorporated herein by reference in its entirety.

### FIELD OF THE INVENTION

Embodiments of the present invention relate to the field of wireless communication networks of optical fibres, and in particular, relates to an improved few-mode optical fiber.

### DESCRIPTION OF THE RELATED ART

Telecommunications networks include access networks where end-user subscribers connect to service providers. With the advancement of science and technology, various modern technologies are being employed for communication purposes. To meet increasing consumer demands, bandwidth requirements for providing high speed data and video services over access networks are growing rapidly. Being one of the most important modern communication technologies, the optical fiber communication technology uses a variety of optical fiber cables.

Optical fiber cables utilize optical fibers to transmit signals such as voice, video, image, data or information. Optical fibers are strands of glass fiber processed so that light beams transmitted through the glass fiber are subject to total internal reflection wherein a large fraction of the incident intensity of light directed into the fiber is received at the other end of the fiber.

Few-mode Optical Fiber (FMF) is a type of optical fiber designed to support multiple spatial modes. The capability of the FMF to support multiple spatial modes enhances data transmission capacity of the FMF. One multiplexing technique adopted while transmitting data through the FMF is Mode Division Multiplexing (MDM) technique. When MDM technique is adopted while transmitting data through the FMF, different modes are used to carry separate data channels.

The key requirements for effective transmission of data using MDM technique in FMF include High Effective Area (Aeff) and Low Differential Mode Delay (DMD). A smaller effective area in the fiber increases nonlinear effects, such as self-phase modulation and four-wave mixing, which can degrade signal quality.

It is well known that nonlinear effects become significant at high optical powers, causing signal distortion. A higher effective area lowers the power density within the fiber, thereby mitigating these effects. By reducing nonlinearities, it is possible to maintain better signal quality over long distances.

Low DMD is essential to minimize intermodal dispersion, which can cause signal overlap and reduce data integrity. It is well known that DMD is the difference in propagation delay between different modes. Low DMD ensures that signals transmitted through various modes arrive with minimal delay difference, reducing the risk of intermodal dispersion. Also, Low DMD maintains the integrity of data channels by preventing signal overlap, which is crucial for maintaining high-speed, error-free communication.

Prior art reference WO2014021894A2, U.S. Pat. No. 9,250,383B2 and U.S. Pat. No. 8,693,834B2, the existing FMF merely offers a trade-off between effective area and DMD. Thus, the existing FMF either have High Effective Area and High DMD or Low Effective Area and Low DMD. The FMF having High Effective Area and High DMD reduce nonlinear effects but suffer from significant intermodal dispersion, limiting their effectiveness for MDM. The FMF having Low Effective Area and Low DMD minimize intermodal dispersion but are prone to nonlinear effects due to the smaller effective area. Also, the conventional FMF has a limited operating range of 1450 nm to 1700 nm. This range confines their applicability and necessitates fibers that can support broader ranges for diverse applications.

Further, the existing FMF does not offer high optical bandwidth, restricting the number of channels that can be transmitted simultaneously. This limitation is a significant drawback in meeting the increasing demand for high-speed data transmission. Thus, there exists a need to provide a FMF that addresses one or more of the aforesaid disadvantages.

Accordingly, to overcome the disadvantages of the prior arts, there is a need for a technical solution that overcomes the above-stated limitations in the prior arts. The present invention provides an improved few-mode optical fiber.

### SUMMARY OF THE INVENTION

Embodiments of the present invention relates to an optical fiber (hereinafter interchangeably referred as few-mode optical fiber) comprising: at least three consecutive up-doped regions (i.e., core regions); and one or more cladding regions surrounding the core regions where the optical fiber enables propagation of exactly two modes.

In accordance with an embodiment of the present invention, the at least three consecutive up-doped regions are defined by a maximum refractive index value. In an aspect of the invention, the at least three consecutive up-doped regions comprising a first up-doped region having a first maximum refractive index (n1max) value, a second up-doped region having a second maximum refractive index (n2max) value, and a third up-doped region having a third maximum refractive index (n3max) value.

In accordance with an embodiment of the present invention, the first maximum refractive index (n1max) value being smaller than the second maximum refractive index (n2max) value and the second maximum refractive index (n2max) value being greater than the third maximum refractive index (n3max) value. In an aspect of the invention, the maximum refractive index of the at least three consecutive regions are related as n2max>n3max>n1max.

In accordance with an embodiment of the present invention, the first up-doped region having a first radius (R1), the second up-doped region having a second radius (R2), and the third up-doped region having a third radius (R3), the first radius (R1) being smaller than the second radius (R2), and the second radius (R2) being greater than the third radius (R3).

In accordance with an embodiment of the present invention, a value of the first maximum refractive index (n1max), a value of the second maximum refractive index (n2max), a value of the third maximum refractive index (n3max), a value of the first radius (R1) of the first up-doped region, a value of the second radius (R2) of the second up-doped region and a value of the third radius (R3) of the third up-doped region are such that the few-mode optical fiber supports a first linearly polarized mode of propagation of optical light (LP₀₁ mode), the first linearly polarized mode (LP₀₁ mode) having no angular variation in the electric field distribution around the core region and the electric field being strongest at a center of the core region and gradually decreasing towards the edges of the core region without dropping to zero at any point within the core region, and a second linearly polarized mode of propagation of optical light (LP₁₁ mode), the second linearly polarized mode (LP₁₁ mode) having one complete cycle of angular variation in the electric field distribution around the core region and the electric field intensity starts strong at the center region, drops to zero at a radial distance from the center of the core region, and then increases again towards the edge of the core region.

In accordance with an embodiment of the present invention, the first linearly polarized mode (LP₀₁ mode) of propagation of optical light has a first mode field diameter (MFD1) in a range of 13.5 μm to 14.6 μm at 1550 nm.

In accordance with an embodiment of the present invention, the second linearly polarized mode (LP₁₁ mode) of propagation of optical light has a second mode field diameter (MFD2) in a range of 14 μm to 15 μm at 1550 nm.

In accordance with an embodiment of the present invention, the value of the first maximum refractive index (n1max), the value of the second maximum refractive index (n2max), the value of the third maximum refractive index (n3max), the value of first radius (R1) of the first up-doped region, the value of the second radius (R2) of the second up-doped region and the value of the third radius (R3) of the third up-doped region are such that the few-mode optical fiber suppresses modes of propagation of optical light other than LP₀₁ mode and LP₁₁ mode through the few-mode optical fiber.

In accordance with an embodiment of the present invention, the first radius (R1) of the first up-doped region being in a range of 1.02 μm to 1.15 μm, the second radius (R2) of the second up-doped region being in a range of 5.9 μm to 6.4 μm, and the third radius (R3) of the third up-doped region being in a range of 8.8 μm to 9.5 μm.

In accordance with an embodiment of the present invention, the first maximum refractive index (n1max) value being in a range of 1.4455-1.4481, the second maximum refractive index (n2max) value being in a range of 1.4478-1.4484, and the third maximum refractive index (n3max) (value) being in a range of 1.4453-1.4465.

In accordance with an embodiment of the present invention, the value of the first maximum refractive index (n1max), the value of the second maximum refractive index (n2max), the value of the third maximum refractive index (n3max), the value of first radius (R1) of the first up-doped region, the value of the second radius (R2) of the second up-doped region and the value of the third radius (R3) of the third up-doped region are such that the LP₀₁ mode of optical light propagates through a first effective area (LP₀₁ Aeff) greater than or equal to 150 μm².

In accordance with an embodiment of the present invention, the value of the first maximum refractive index (n1max), the value of the second maximum refractive index (n2max), the value of the third maximum refractive index (n3max), the value of first radius (R1) of the first up-doped region, the value of the second radius (R2) of the second up-doped region and the value of the third radius (R3) of the third up-doped region are such that the LP₁₁ mode of optical light propagates through has a second effective area (LP₁₁ Aeff) greater than 200 μm².

In accordance with an embodiment of the present invention, the value of the first maximum refractive index (n1max), the value of the second maximum refractive index (n2max), the value of the third maximum refractive index (n3max), the value of first radius (R1) of the first up-doped region, the value of the second radius (R2) of the second up-doped region and the value of the third radius (R3) of the third up-doped region are such that a maximum differential mode delay between the LP₀₁ mode of propagation of optical light through the few-mode optical fiber and the LP₁₁ mode of propagation of optical light through the few-mode optical fiber being less than or equal to 50 ps/km at a wavelength of 1550 nm.

In accordance with an embodiment of the present invention, the at least three consecutive up-doped regions (i.e., core region) and the cladding region are free from down-dopants.

In accordance with an embodiment of the present invention, a glass diameter (128) of the optical fiber (100) being greater than or equal to 80 μm and less than or equal to 130 μm and a coating diameter of the optical fiber (100) with the coating layer (112) being in a range of 135 μm to 270 μm.

In accordance with an embodiment of the present invention, the few-mode optical fiber comprises a coating layer on an external peripheral surface of the cladding region.

The foregoing objectives of the present invention are attained by employing an improved few-mode optical fiber.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and a person of ordinary skill in the art can derive other implementations from these accompanying drawings without creative efforts. All of the embodiments or the implementations shall fall within the protection scope of the present invention.

FIG. 1 illustrates a cross-sectional view of a optical fiber in accordance with an embodiment of the present invention;

FIG. 2 illustrates a change in the refraction index of the core portion in relation with a radius of the core in the optical fiber in accordance with an embodiment of the present invention;

FIG. 3 illustrates a change in the refraction index of the core portion in relation with a radius of the core in the optical fiber in accordance with another embodiment of the present invention;

FIG. 4 illustrates the first linearly polarized mode of propagation of optical light which is allowed in the optical fiber in accordance with the present invention;

FIG. 5 illustrates the second linearly polarized mode of propagation of optical light which is allowed in the optical fiber in accordance with the present invention;

FIG. 6 illustrates a third linearly polarized mode of propagation of optical light which is prohibited in the optical fiber in accordance with the present invention;

FIG. 7 illustrates a fourth linearly polarized mode of propagation of optical light which is prohibited in the optical fiber in accordance with the present invention;

FIG. 8 illustrates a graph depicting the effect of the first maximum refractive index (n1max) of the first up-doped region and the value of first radius of the first up-doped region on the Differential Mode Delay (DMD) of the optical fiber in accordance an embodiment with the present invention;

FIG. 9 illustrates a graph depicting the effect of the second maximum refractive index (n2max) of the second up-doped region and the value of second radius of the second up-doped region on the Differential Mode Delay (DMD) of the optical fiber in accordance an embodiment with the present invention;

FIG. 10 illustrates a graph depicting the effect of the third maximum refractive index (n3max) of the third up-doped region and the value of third radius of the third up-doped region on the Differential Mode Delay (DMD) of the optical fiber in accordance an embodiment with the present invention.

The optical fiber is illustrated in the accompanying drawings, which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DESCRIPTION OF EMBODIMENTS

Those skilled in the art will be aware that the present invention is subject to variations and modifications other than those specifically described. It is to be understood that the present invention includes all such variations and modifications. The invention also includes all such steps, features, compositions and compounds referred to or indicated in this specification, individually or collectively, and any and all combinations of any or more of such steps or features.

### Definitions

For convenience, before further description of the present invention, certain terms employed in the specification, and examples are collected here. These definitions should be read in the light of the remainder of the invention and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”. Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The following brief definition of terms shall apply throughout the present invention:

Few-mode optical fiber—The mode division multiplexing (MDM) transmission system uses the limited orthogonal modes in few-mode optical fiber (FMF) as the independent channels to carry out information transmission in order to multiply the transmission capacity of the system. The few-mode optical fiber allows a few numbers of modes for example, 2 to 6 modes depending on the application and design of the few-mode optical fiber and cut-off all other modes. The few-mode optical fiber disclosed in the present invention has step index core regions and step index cladding region. The few-mode optical fiber uses different modes in the fiber as a new degree of freedom, the spectrum efficiency of the system can be improved successfully by FMF.

LP₀₁—A linearly polarized (LP) mode is referred to as LPₗₘ, where the l and m subscripts are related to the number of radial and azimuthal zeros of a particular mode.

LP₁₁—A linearly polarized (LP) mode is referred to as LPₗₘ, where the l and m subscripts are related to the number of radial and azimuthal zeros of a particular mode.

Core region—The term core region as used herein refers to an innermost cylindrical structure present in the center of the few-mode optical fiber, that is conFig.d to guide the light rays inside the few-mode optical fiber.

Cladding region—The term cladding region as used herein refers to one or more layered structure covering the core region of the few-mode optical fiber from the outside, that is conFig.d to possess a lower refractive index than the refractive index of the core region to facilitate total internal reflection of light rays inside the optical fiber. Further, the cladding region of the few-mode optical fiber may include an inner cladding layer coupled to the outer surface of the core region of the few-mode optical fiber and an outer cladding layer coupled to the inner cladding from the outside.

Up dopant—The term “up dopant” as used herein is referred to doping material(s), which upon addition, facilitate increase in the refractive index of a particular layer or part of the few-mode optical fiber. Some of the commonly available up dopants are Germanium (in the form of Germanium dioxide), Phosphorous (in the form of Phosphorus pentoxide), Aluminum (in the form of Aluminum oxide). Specifically, the “up dopant” as used herein is Germanium.

Down dopant—The term “down dopant” as used herein is referred to doping material(s), which upon addition, facilitate decrease in the refractive index of a particular layer or part of the few-mode optical fiber. Some of the commonly available “down dopants” are Fluorine and Boron (in the form of Boron oxide). Specifically, the “down dopant” as used herein is Fluorine.

Other dopant—The term “other dopant” as used herein is referred to doping material(s), which upon addition, modify one or more of the viscosity of the glass, thermal properties of the glass, water content in the fiber, etc. making it easier to manufacture the fiber, increase purity of the fiber and/or reduce defects in the glass. Some of the commonly available “other dopants” are Chlorine, Nitrogen, Hydrogen, Magnesium, Calcium, etc. Specifically, the “other dopant” as used herein is Chlorine.

Un doped region—The term “un-doped” as used herein is referred to as a material that is not intentionally doped, or which is pure silica. However, there are always chances of some diffusion of dopants in the region which is negligible.

Trench—The term “trench” as used herein is referred to as a down-doped region with a higher down-dopant concentration to decrease the refractive index of the down-doped region with respect to pure silica and increase the relative refractive index of the core.

Refractive index—The term “refractive index” as used herein is referred to as the measure of change of speed of light from one medium to another and is particularly measured in reference to speed of light in vacuum. More specifically, the refractive index facilitates measurement of bending of light from one medium to another medium.

Refractive index profile—The term “refractive index profile” of the optical fiber as used herein is referred to as a distribution of refractive indexes in the optical fiber from the core to the outermost cladding layer of the optical fiber. Based on the refractive index profile, the optical fiber may be conFig.d as a step index fiber. The refractive index of the core of the optical fiber is constant throughout the fiber and is higher than the refractive index of the cladding. Further, the optical fiber may be conFig.d as a graded index fiber, wherein the refractive index of the core gradually varies as a function of the radial distance from the center of the core.

Mode field diameter—The term “Mode Field Diameter (MFD)” as used herein is referred to as the size of the light-carrying portion of the optical fiber. For single-mode optical fibers, this region includes the optical fiber core as well as a small portion of the surrounding cladding glass of the optical fiber. The selection of desired MFD helps to describe the size of the light-carrying portion of the optical fiber.

Effective area—It is a quantitative measure of the area which a fiber mode effectively covers in the transverse dimensions. By using the Petermann definition, (where E(r) is the modal field along the radial parameter), the effective area is defined as:

$${A}_{eff} = \{ \frac{2 {π [ {\int }_{0}^{∞} {E ( r )}^{2} r dr ]}^{2}}{{\int }_{0}^{∞} {E ( r )}^{4} r dr} \}$$

Cable cut-off—The term “cable cut-off wavelength” as used herein refers to a wavelength above which the fiber will support and propagate only the desired mode of light. If the cable cut-off value of an optical fiber is beyond the cut-off value, the optical fiber may not be compatible with typical telecommunication applications. The cabled cutoff wavelength, or “cabled cut-off can be approximated by the 22 m cabled cutoff test described in EIA-455-170 Cable Cutoff Wavelength of Single-mode Fiber by Transmitted Power, or “FOTP-170”. Cable cutoff, as used herein, means the value obtained using the approximated test.

Differential mode delay (differential mode group delay)—Differential mode delays (DMD) or modal differential group delay (DGD) are signal distortions due to different propagation times of modes in optical fibers. They are also referred to as multimode group delays because lower and higher order modes propagate differently in multimode fibers and thus have different propagation times. When light signals are transmitted in optical fibers, they are deformed by dispersion. The transmitted light pulses are thus broadened and flattened, leading to the corresponding DMD delays. In Gigabit Ethernet and in even faster Ethernet variants, the DMD distortions can affect the transmission specifications. They are therefore specified. DMD is related to intermodal dispersion.

Differential modal delay (DMD) or differential modal group delay (DGD) is provided by the formula=ps/km

$$= \frac{1}{{V}_{g 11}} - \frac{1}{{V}_{g 01}} = \frac{d {β}_{11}}{d ω} - \frac{d {β}_{01}}{d ω} = - \frac{{λ}^{2}}{2 π c} ( \frac{d {β}_{11}}{d λ} - \frac{d {β}_{01}}{d λ} ) ps / km$$

Wherein: V=Group velocity, w=angular frequency, B=Propagation constant at LP01 or LP11 mode, A=Wavelength, L=Length

Available BW is given by the formula=(L in km*0.44*10¹²)/(DMD in ps/km) Hz

By way of example, if typical value of DMD01 which is differential group delay between the fundamental mode (mode 0) and the first-order mode (mode 1) is 4889600 ps/km and if typical value of DMD11 which is the differential group delay between two first-order modes (mode 1) is 4891704 ps/km; then DMD=4891704-4889600=2104 ps/km and Approximate BW=209 MHz.

By way of another example, if the typical value of DMD is 300 ps/km then approximate BW=1467 MHz;

By way of yet another example, if the typical value of DMD is 4 ps/km DMD, then approximate BW=110 GHz.

Coating layers—The bare fiber (i.e., glass fiber) is coated with one or more primary coating layers and secondary coating layers or an ink layer.

Bare fiber—The term “bare fiber” as used herein is referred to as a glass optical fiber excluding one or more coatings on the optical fiber.

Dispersion—In an optical fiber, dispersion is the phenomena wherein light waves of different wavelengths go through the fiber at different speeds. It results in light pulses spreading out over time, deteriorating the signal and reducing the fiber's ability to transmit data. Unit of dispersion is picosecond/(kilometer·nanometer)

Dispersion slope—The variation in the optical fiber's dispersion with respect to wavelength is known as the dispersion slope. It has the unit ps/(km·nm²).

Step index profile vs graded index-Optical fibers with a nearly constant refractive index at the core are known as step index fibers. The refractive index of the cladding is lower than that of the core with sharp decrease/transition in the refractive index value at the core-clad interface whereas graded index fibers are optical fibers having core refractive index that gradually reduces to approach the cladding refractive index value at the interface. In these types of fibers, the maximum refractive index is found at the core center.

Intermodal dispersion-When an optical pulse is launched into the multimode fiber (MMF), the optical power of the pulse is typically distributed among a large number of fiber modes. Different modes travel through the fiber at different propagation velocities. It means that the different modes launched at the same time reach the output end of the fiber at different times. Therefore, the optical pulse broadens in time as it travels along the MMF. This pulse broadening effect is known as modal dispersion.

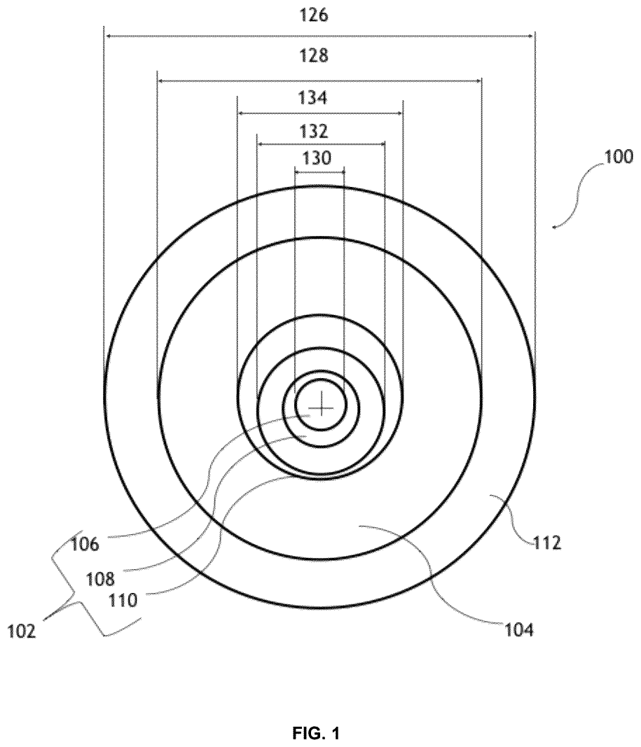

FIG. 1 illustrates a cross-sectional view of an optical fiber in accordance with an embodiment of the present invention. The optical fiber (100) (hereinafter interchangeably referred as a few-mode optical fiber) in accordance with an embodiment of the present invention. In particular, the optical fiber (100) comprises at least three consecutive up-doped regions (102) (hereinafter interchangeably referred as core regions) comprising at least three consecutive up-doped regions; and one or more cladding regions (104) surrounding the at least three consecutive up-doped regions (102) such that the optical fiber (100) enables propagation of exactly two modes.

Further, at least three consecutive up-doped regions (102) comprise a first up-doped region (106), a second up-doped region (108) and a third up-doped region (110). The first up-doped region (106), the second up-doped region (108) and the third up-doped region (110) are concentric in a cross-sectional view of the few-mode optical fiber (100).

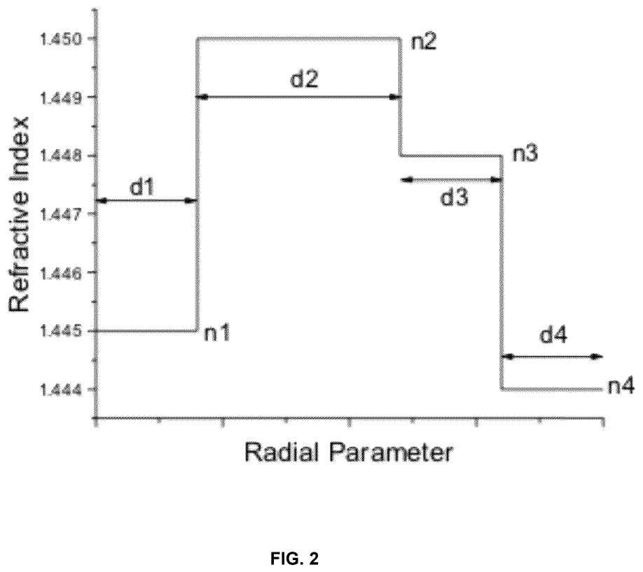

FIG. 2 illustrates a change in the refraction index of the core portion in relation with a radius of the core in the optical fiber in accordance with an embodiment of the present invention.

From the change in the refractive index of the at least three consecutive up-doped regions (102) in relation with a radius of the at least three consecutive up-doped regions (102) in the optical fiber (100) in accordance with an embodiment of the present invention can be seen that the first up-doped region (106) has a first maximum refractive index (n1max), the second up-doped region (108) has a second maximum refractive index (n2max), and the third up-doped region (110) has a third maximum refractive index (n3max).

In accordance with an embodiment of the present invention, the first maximum refractive index (n1max) is smaller than the second maximum refractive index (n2max) and the second maximum refractive index (n2max) is greater than the third maximum refractive index (n3max). In particular, the first maximum refractive index (n1max) is smaller than the third maximum refractive index (n3max). Further, the first maximum refractive index (n1max) is greater than the third maximum refractive index (n3max).

In accordance with an embodiment of the present invention, the refractive index profile in the at least three consecutive up-doped regions (102) of the optical fiber (100) is in the form of step index profile. In particular, the first up-doped region (106) has a constant refractive index having the first maximum refractive index (n1max). Moreover, the refractive index sharply transitions to the second maximum refractive index (n2max) which then remains constant in the second up-doped region (108). Further, the refractive index sharply transitions from the second maximum refractive index (n2max) to the third maximum refractive index (n3max) which then remains constant in the third up-doped region (110). Furthermore, the first up-doped region (106) has an approximately constant refractive index having the first maximum refractive index (n1max).

In accordance with an embodiment of the present invention, when the refractive index sharply transitions to the second maximum refractive index (n2max) which then remains approximately constant in the second up-doped region (108). Further, the refractive index sharply transitions from the second maximum refractive index (n2max) to the third maximum refractive index (n3max) which then remains approximately constant in the third up-doped region (110).

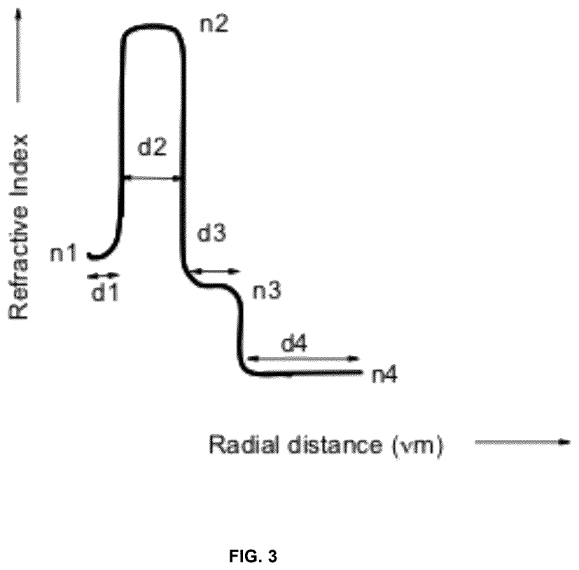

FIG. 3 illustrates a change in the refraction index of the core portion in relation with a radius of the core in the optical fiber in accordance with another embodiment of the present invention. In particular, the refractive index profile in the at least three consecutive up-doped regions (102) of the optical fiber (100) is in the form of a substantially step index profile (i.e., experimental refractive index profile of the optical fiber (100)) as shown in FIG. 3. Moreover, the first up-doped region (106) has a nearly constant refractive index having the first maximum refractive index (n1max). Further, the refractive index transitions to the second maximum refractive index (n2max) which then remains nearly constant in the second up-doped region (108). Furthermore, the refractive index sharply transitions from the second maximum refractive index (n2max) to the third maximum refractive index (n3max) which then remains nearly constant in the third up-doped region (110).

In accordance with an embodiment of the present invention, the at least three consecutive up-doped regions (102) are up-doped with one or more up-dopants such as GeO2, Al2O3 or P2O3. The boundaries of the first up-doped region (106), the second up-doped region (108), and the third up-doped region (110) are distinguished from the concentration of up-dopants used in the different regions by using the refractive index (RI) value in the different regions.

In an exemplary example, if RI=1.44402 at 1550 nm in one of the region of the few-mode optical fiber (100), this particular region is pure silica (i.e., un doped region) which is the refractive index of the cladding region (104). When the up doping is performed in any region such as the at least three consecutive up-doped regions (102) of the optical fiber (100) that will lead to increment in the RI value which is expected to be more than 1.44402.

Mathematically the boundaries of different regions such as the first up-doped region (106), the second up-doped region (108) and the third up-doped region (110) and the cladding region (104) may be identified by taking first or second order derivative of the RI profile where positive or negative peaks determine the boundary values. Further, the boundaries of the different regions such as the first up-doped region (106), the second up-doped region (108) and the third up-doped region (110) and the cladding region (104) may be identified by the thickness of the different regions and immediate transitions in the RI values.

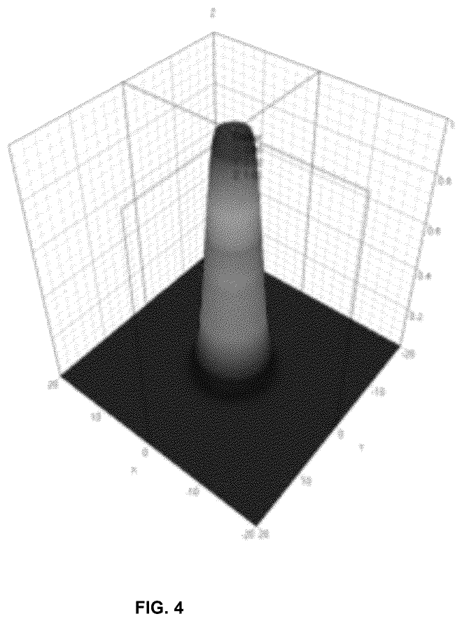

FIG. 4 illustrates the first linearly polarized mode of propagation of optical light which is allowed in the optical fiber in accordance with the present invention. In particular, value of the first maximum refractive index (n1max), value of the second maximum refractive index (n2max), value of the third maximum refractive index (n3max), value of first radius (130) of the first up-doped region (106), value of the second radius (132) of the second up-doped region (108) and value of the third radius (134) of the third up-doped region (110) are such that the few-mode optical fiber (100) supports a first linearly polarized mode of propagation of optical light (LP₀₁ mode) as shown in FIG. 4. Further, the first linearly polarized mode (LP₀₁ mode) has no angular variation in the electric field distribution around the core region (102) and the electric field being strongest at a center of the core region (102) and gradually decreasing towards the edges of the core region (102) without dropping to zero at any point within the core region (102).

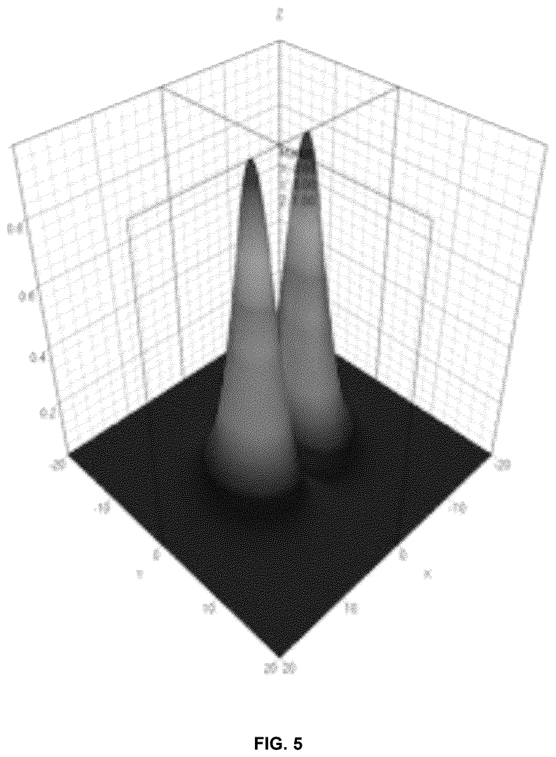

FIG. 5 illustrates the second linearly polarized mode of propagation of optical light which is allowed in the optical fiber in accordance with the present invention. In particular, value of the first maximum refractive index (n1max), value of the second maximum refractive index (n2max), value of the third maximum refractive index (n3max), value of first radius (130) of the first up-doped region (106), value of the second radius (132) of the second up-doped region (108) and value of the third radius (134) of the third up-doped region (110) are such that the optical fiber (100) also supports a second linearly polarized mode of propagation of optical light (LP₁₁ mode) as shown in FIG. 5. Moreover, the second linearly polarized mode (LP₁₁ mode) has one complete cycle of angular variation in the electric field distribution around the core region (102) and the electric field intensity starts strong at the center region (102), drops to zero at a radial distance from the center of the core region (102), and then increases again towards the edge of the core region (102).

Further, value of the first maximum refractive index (n1max), value of the second maximum refractive index (n2max), value of the third maximum refractive index (n3max), value of first radius (130) of the first up-doped region (106), value of the second radius (132) of the second up-doped region (108) and value of the third radius (134) of the third up-doped region (110) are such that the optical fiber (100) suppresses modes of propagation of optical light other than LP₀₁ mode and LP₁₁ mode through the optical fiber (100).

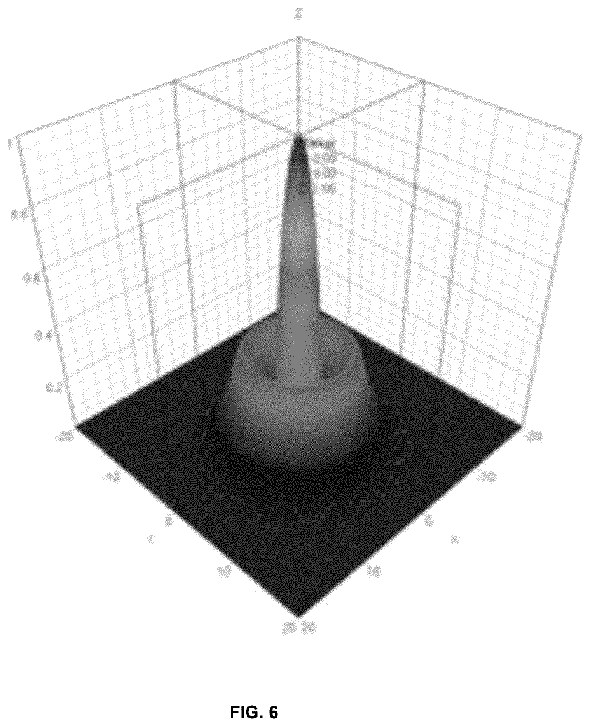

FIG. 6 illustrates a third linearly polarized mode of propagation of optical light which is prohibited in the optical fiber in accordance with the present invention. The optical fiber (100) suppresses a third linearly polarized mode of propagation (LP 02) of optical light as shown in FIG. 6 from propagating through the optical fiber (100) in accordance with the present invention.

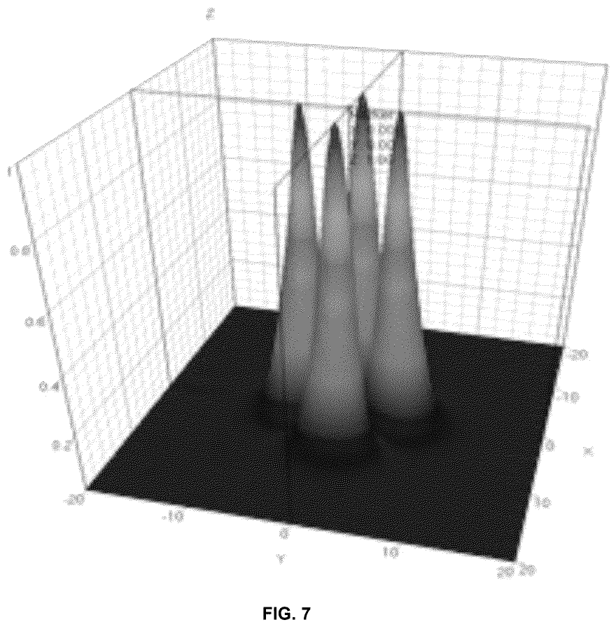

FIG. 7 illustrates a fourth linearly polarized mode of propagation of optical light which is prohibited in the optical fiber in accordance with the present invention. Further, the optical fiber (100) suppresses a fourth linearly polarized mode of propagation (LP₂₁) of optical light as shown in FIG. 7 from propagating through the optical fiber (100) in accordance with the present invention.

In accordance with an embodiment of the present invention, the first linearly polarized mode (LP₀₁ mode) of propagation of optical light has a first mode field diameter (MFD1) in a range of 13.5 μm to 14.6 μm at 1550 nm and the second linearly polarized mode (LP₁₁ mode) of propagation of optical light having a second mode field diameter (MFD2) in a range of 14 μm to 15 μm at 1550 nm.

Now referring back to FIG. 1, the first up-doped region (106) has a first radius (130), the second up-doped region (108) has a second radius (132), and the third up-doped region (110) has a third radius (134). In particular, the first radius (130) is smaller than the second radius (132), and the second radius (132) is greater than the third radius (134). In an embodiment of the invention, the first radius (130) is smaller than the third radius (134). Alternatively, the first radius (130) is greater than the third radius (134).

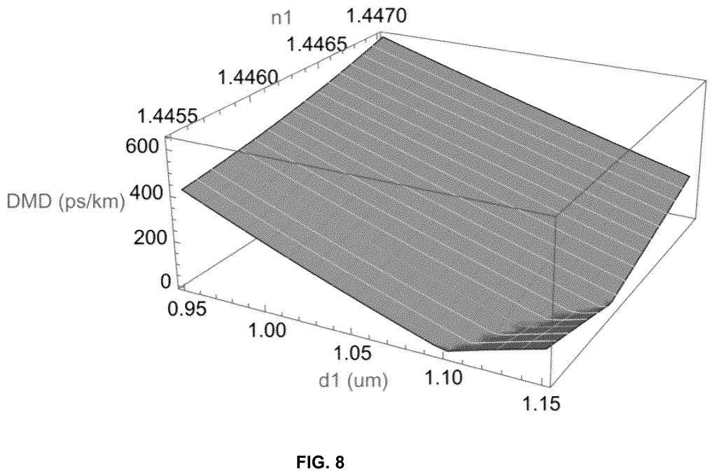

FIG. 8 illustrates a graph depicting the effect of the first maximum refractive index (n1max) of the first up-doped region and the value of first radius of the first up-doped region on the Differential Mode Delay (DMD) of the optical fiber in accordance an embodiment with the present invention. The graph depicting the effect of the first maximum refractive index (n1max) of the first up-doped region (106) and the value of first radius (R1=d1) of the first up-doped region (106) on the Differential Mode Delay (DMD) of the few-mode optical fiber (100). It can be seen from FIG. 8 that for a specific value of second radius (R2) (132), a specific value of the third radius (R3) (134), a specific value of the second maximum refractive index (n2max), a specific value of the third maximum refractive index (n3max), the DMD is based on the values of the first radius (R1) (130) and values of the first maximum refractive index (n1max). Particularly, it can be seen that when the thickness (d2) of the second up-doped region (108) is 5.1 μm, the thickness (d3) of the third up-doped region (110) is 2.96 μm, the second maximum refractive index (n2max) has a value of 1.4481, and the third maximum refractive index (n3max) has a value of 1.4457, there is U-type variations in DMD values with respect to the values of the first radius (130) and values of the first maximum refractive index (n1max).

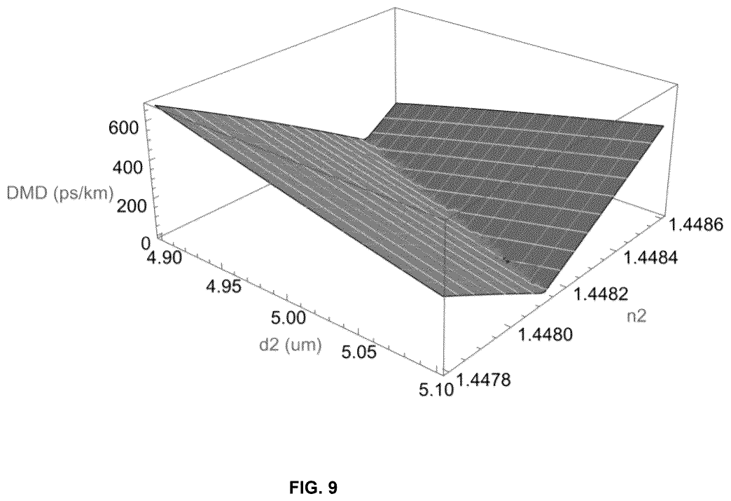

FIG. 9 illustrates a graph depicting the effect of the second maximum refractive index (n2max) of the second up-doped region and the value of second radius of the second up-doped region on the Differential Mode Delay (DMD) of the optical fiber in accordance an embodiment with the present invention. The graph depicting the effect of the second maximum refractive index (n2max) of the second up-doped region (108) and the value of second radius (R2=d1+d2) of the second up-doped region (108) on the Differential Mode Delay (DMD) of the few-mode optical fiber (100). It can be seen from FIG. 9 that for a specific value of first radius (130), a specific value of the third radius (134), a specific value of the first maximum refractive index (n1max), a specific value of the third maximum refractive index (n3max), the DMD is based on the values of the second radius (132) and values of the second maximum refractive index (n1max). Particularly, it can be seen that when the first radius (R1=d1) (130) is 1.11499 μm, the thickness (d3) of the third up-doped region (110) is 2.96 μm, the first maximum refractive index (n1max) has a value of 1.4459, and the third maximum refractive index (n3max) has a value of 1.4457, there is U-type variations in DMD values with respect to the values of the second radius (132) and values of the second maximum refractive index (n2max).

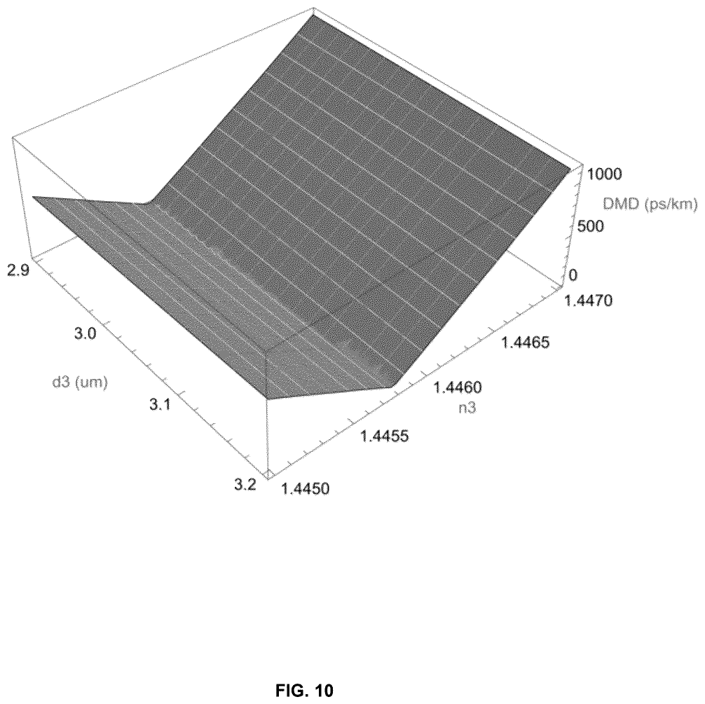

FIG. 10 illustrates a graph depicting the effect of the third maximum refractive index (n3max) of the third up-doped region and the value of third radius of the third up-doped region on the Differential Mode Delay (DMD) of the optical fiber in accordance an embodiment with the present invention. The graph depicting the effect of the third maximum refractive index (n3max) of the third up-doped region (110) and the value of third radius (R3=d1+d2+d3) of the third up-doped region (110) on the Differential Mode Delay (DMD) of the few-mode optical fiber (100) in accordance an embodiment with the present invention. It can be seen from FIG. 10 that for a specific value of first radius (130), a specific value of the second radius (132), a specific value of the first maximum refractive index (n1max), a specific value of the second maximum refractive index (n2max), the DMD is based on the values of the third radius (134) and values of the third maximum refractive index (n3max). Further, it can be seen that when the first radius (R1=d1) (130) is 1.11499 μm, the first maximum refractive index (n2max) has a value of 1.4459, the thickness of the second up-doped region (108) is 5.1 μm, and the second maximum refractive index (n2max) has a value of 1.4481, there is U-type variations in DMD values with respect to the values of the third radius (134) and values of the third maximum refractive index (n3max).

Therefore, in order to maintain substantially low DMD values, the value of the first maximum refractive index (n1max), the value of the second maximum refractive index (n2max), the value of the third maximum refractive index (n3max), the value of first radius (R1) (130) of the first up-doped region (106), the value of the second radius (R2) (132) of the second up-doped region (108) and the value of the third radius (R3) (134) of the third up-doped region (110) has to be chosen so as to correspond to the each of the three U curves as shown in FIG. 8, FIG. 9, and FIG. 10.

In accordance with an embodiment of the present invention, if the first radius (R1=d1) (130) of the first up-doped region (106) is maintained in a range of 1.02 μm to 1.15 μm, the second radius (R2=R1+d2) (132) of the second up-doped region (108) is maintained in a range of 5.9 μm to 6.4 μm, the third radius (R3=d3+R2) (134) of the third up-doped region (110) is maintained in a range of 8.8 μm to 9.5 μm; the first maximum refractive index (n1max) is maintained in a range of 1.4455 to 1.4481, the second maximum refractive index (n2max) is maintained in a range of 1.4478 to 1.4484, and the third maximum refractive index (n3max) is maintained in a range of 1.4453 to 1.4465; the effective area is greater than 200 μm² and differential mode delay is less than 50 ps per km at a wavelength of 1550 nm.

In accordance with an embodiment of the present invention, the difference in effective refractive index for LP₀₁ mode and LP₁₁ mode which is provided by the following formula can be kept at a value greater than 0.0015.

$$Δ {N}_{eff} = {N}_{eff} ( {LP}_{01} ) - {N}_{eff} ( {LP}_{11} )$$

When the value of ΔN_{eff} is greater than 0.0015, a significant separation between the propagation constants of these modes is achieved which leads to reducing losses as well as minimizing dispersion.

In accordance with an embodiment of the present invention, when the value of the first maximum refractive index (n1max), the value of the second maximum refractive index (n2max), the value of the third maximum refractive index (n3max), the value of first radius (R1) (130) of the first up-doped region (106), the value of the second radius (R2) (132) of the second up-doped region (108) and the value of the third radius (R3) (134) of the third up-doped region (110) are such that the LP₀₁ mode of optical light propagates through a first effective area (LP₀₁ Aeff) greater than 150 μm², and the LP₁₁ mode of optical light propagates through has a second effective area (LP₁₁ Aeff) greater than 200 μm².

In accordance with an embodiment of the present invention, at least three consecutive up-doped regions (102) and the one or more cladding regions (104) being free from down-dopants. In particular, the few-mode optical fiber is purely silica cladding type few-mode optical fiber where the one or more cladding region (104) is independent of any down dopants so that the pure silica (i.e., un doped) cladding helps in maintaining high tensile strength at low manufacturing complexities and low cost of the few-mode optical fiber. Moreover, a combined glass diameter (128) of the at least three consecutive up-doped regions (102) and the cladding region (104) is greater than or equal to 80 μm and less than or equal to 130 μm. Further, a diameter (126) of the optical fiber (100) with the coating layer (112) surrounding the cladding region (104) being in a range of 135 μm to 270 μm.

To establish the working of the invention, the following examples are provided.

### Example-1

A few-mode optical fiber having the value of the first maximum refractive index (n1max) as 1.4455, the value of the second maximum refractive index (n2max) as 1.4482, the value of the third maximum refractive index (n3max) as 1.4456, the value of first radial thickness (d1) of the first up-doped region (106) as 1.03 μm, the value of the second radial thickness (d2) of the second up-doped region (108) as 5.214742 μm and the value of the third radial thickness of the third up-doped region (110) as 2.98 μm is prepared and the tested.

The few-mode optical fiber (100) thus obtained has the properties as mentioned in Table 1:

TABLE 1

| Parameter | Value | |
|---|---|---|
| LP01 GD | 4893726 | ps/km |
| LP01 D1550 | 21.12 | ps/(nm · km) |
| LP01 MFD | 13.67 | μm |
| LP01 Aeff | 159.4 | μm² |
| LP11 GD | 4893726 | ps/km |
| LP11 D1550 | 14.2656 | ps/(nm · km) |
| LP11 MFD | 14.1011 | μm |
| LP11 Aeff | 199.96 | μm² |
| DMD | 0 | ps/km |
| LP02 Cutoff | 1.2947 | μm |
| LP21 Cutoff | 1.2918 | μm |
| LP11 Cutoff | 2.0819 | μm |

### Example-2

In Example 2, the value of the first maximum refractive index (n1max) is 1.4457, the value of the second maximum refractive index (n2max) is 1.4481, the value of the third maximum refractive index (n3max) is 1.4457, the value of first radial thickness (d1) of the first up-doped region (106) is 1.09 μm, the value of the second radial thickness (d2) of the second up-doped region (108) is 5.156674 μm and the value of the third radial thickness (d3) of the third up-doped region (110) is 2.95 μm. The few-mode optical fiber (100) thus obtained has the properties as mentioned in Table 2:

TABLE 2

| Parameter | Value | |
|---|---|---|
| LP01 GD | 4893338 | ps/km |
| LP01 D1550 | 21.176 | ps/(nm · km) |
| LP01 MFD | 13.8658 | μm |
| LP01 Aeff | 163.59 | μm² |
| LP11 GD | 4893338 | ps/km |
| LP11 D1550 | 14.6372 | ps/(nm · km) |
| LP11 MFD | 14.2876 | μm |
| LP11 Aeff | 205.87 | μm² |
| DMD | 0 | ps/km |
| LP02 Cutoff | 1.2960 | μm |
| LP21 Cutoff | 1.2934 | μm |
| LP11 Cutoff | 2.0830 | μm |

### Example-3

In Example 3, the value of the first maximum refractive index (n1max) is 1.4457, the value of the second maximum refractive index (n2max) is 1.4478, the value of the third maximum refractive index (n3max) is 1.4458, the value of first radial thickness (d1) of the first up-doped region (106) is 1.125 μm, the value of the second radial thickness (d3) of the second up-doped region (108) is 5.2 μm and the value of the third radial thickness (d3) of the third up-doped region (110) is 2.97 μm. The few-mode optical fiber (100) thus obtained has the properties as mentioned in Table 3:

TABLE 3

| Parameter | Value | |
|---|---|---|
| LP01 GD | 4892584 | ps/km |
| LP01 D1550 | 21.2353 | ps/(nm · km) |
| LP01 MFD | 14.2695 | μm |
| LP01 Aeff | 173.52 | μm² |
| LP11 GD | 4892584 | ps/km |
| LP11 D1550 | 15.3544 | ps/(nm · km) |
| LP11 MFD | 14.677 | μm |
| LP11 Aeff | 216.51 | μm² |
| DMD | 0 | ps/km |
| LP02 Cutoff | 1.3 | μm |
| LP21 Cutoff | 1.2982 | μm |
| LP11 Cutoff | 2.0876 | μm |

### Example-4

In Example 4, the value of the first maximum refractive index (n1max) is 1.4458, the value of the second maximum refractive index (n2max) is 1.4478, the value of the third maximum refractive index (n3max) is 1.4459, the value of first radial thickness (d1) of the first up-doped region (106) is 1.145 μm, the value of the second radial thickness (d2) of the second up-doped region (108) is 5.179 μm and the value of the third radial thickness (d3) of the third up-doped region (110) is 2.96 μm. The few-mode optical fiber (100) thus obtained has the properties as mentioned in Table 4:

TABLE 4

| Parameter | Value | |
|---|---|---|
| LP01 GD | 4892235 | ps/km |
| LP01 D1550 | 21.2647 | ps/(nm · km) |
| LP01 MFD | 14.4551 | μm |
| LP01 Aeff | 176.63 | μm² |
| LP11 GD | 4892235 | ps/km |
| LP11 D1550 | 15.5729 | ps/(nm · km) |
| LP11 MFD | 14.8721 | μm |
| LP11 Aeff | 221.58 | μm² |
| DMD | 0 | ps/km |
| LP02 Cutoff | 1.3 | μm |
| LP21 Cutoff | 1.2983 | μm |
| LP11 Cutoff | 2.0865 | μm |

### Example-5

In Example 5, the value of the first maximum refractive index (n1max) is 1.4458, the value of the second maximum refractive index (n2max) is 1.4478, the value of the third maximum refractive index (n3max) is 1.4459, the value of first radial thickness (d1) of the first up-doped region (106) is 1.145 μm, the value of the second radial thickness (d2) of the second up-doped region (108) is 5.224901961 μm and the value of the third radial thickness (d3) of the third up-doped region (110) is 2.96 μm. The few-mode optical fiber (100) thus obtained has the properties as mentioned in Table 5:

TABLE 5

| Parameter | Value | |
|---|---|---|
| LP01 GD | 4892235 | ps/km |
| LP01 D1550 | 21.2647 | ps/(nm · km) |
| LP01 MFD | 14.4551 | μm |
| LP01 Aeff | 176.63 | μm² |
| LP11 GD | 4892235 | ps/km |
| LP11 D1550 | 15.5729 | ps/(nm · km) |
| LP11 MFD | 14.8721 | μm |
| LP11 Aeff | 221.58 | μm² |
| DMD | 0 | ps/km |
| LP02 Cutoff | 1.3 | μm |
| LP21 Cutoff | 1.2983 | μm |
| LP11 Cutoff | 2.0865 | μm |

### Example-6

In Example 6, the value of the first maximum refractive index (n1max) is 1.4455, the value of the second maximum refractive index (n2max) is 1.4482, the value of the third maximum refractive index (n3max) is 1.4457, the value of first radial thickness (d1) of the first up-doped region (106) is 1.02 μm, the value of the second radial thickness (d2) of the second up-doped region (108) is 5.17948 μm and the value of the third radial thickness (d3) of the third up-doped region (110) is 2.95 μm. The few-mode optical fiber (100) thus obtained has the properties as mentioned in Table 6:

TABLE 6

| Parameter | Value | |
|---|---|---|
| LP01 GD | 4893713 | ps/km |
| LP01 D1550 | 21.1459 | ps/(nm · km) |
| LP01 MFD | 13.6938 | μm |
| LP01 Aeff | 159.97 | μm² |
| LP11 GD | 4893713 | ps/km |
| LP11 D1550 | 14.4726 | ps/(nm · km) |
| LP11 MFD | 14.1168 | μm |
| LP11 Aeff | 200.81 | μm² |
| DMD | 0 | ps/km |
| LP02 Cutoff | 1.2994 | μm |
| LP21 Cutoff | 1.2951 | μm |
| LP11 Cutoff | 2.0867 | μm |

### Example-7

In Example 7, the value of the first maximum refractive index (n1max) is 1.4457, the value of the second maximum refractive index (n2max) is 1.4478, the value of the third maximum refractive index (n3max) is 1.4458, the value of first radial thickness (d1) of the first up-doped region (106) is 1.125 μm, the value of the second radial thickness (d2) of the second up-doped region (108) is 5.2 μm and the value of the third radial thickness (d3) of the third up-doped region (110) is 2.97 μm. The few-mode optical fiber (100) thus obtained has the properties as mentioned in Table 7:

TABLE 7

| Parameter | Value | |
|---|---|---|
| LP01 GD | 4892234.90 | ps/km |
| LP01 D1550 | 21.26 | ps/(nm · km) |
| LP01 MFD | 14.45 | μm |
| LP01 Aeff | 176.64 | μm² |
| LP11 GD | 4892233.40 | ps/km |
| LP11 D1550 | 15.55 | ps/(nm · km) |
| LP11 MFD | 14.87 | μm |
| LP11 Aeff | 221.66 | μm² |
| DMD | 1.50 | ps/km |
| LP02 Cutoff | 1.2985 | μm |
| LP21 Cutoff | 1.2952 | μm |
| LP11 Cutoff | 2.0817 | μm |

### Example-8

In Example 8, the value of the first maximum refractive index (n1max) is 1.4457, the value of the second maximum refractive index (n2max) is 1.4479, the value of the third maximum refractive index (n3max) is 1.4459, the value of first radial thickness (d1) of the first up-doped region (106) is 1.11 μm, the value of the second radial thickness (d2) of the second up-doped region (108) is 5.119 μm and the value of the third radial thickness (d3) of the third up-doped region (110) is 2.95 μm. The few-mode optical fiber (100) thus obtained has the properties as mentioned in Table 8:

TABLE 8

| Parameter | Value | |
|---|---|---|
| LP01 GD | 4892583.40 | ps/km |
| LP01 D1550 | 21.22 | ps/(nm · km) |
| LP01 MFD | 14.3 | μm |
| LP01 Aeff | 173.49 | μm² |
| LP11 GD | 4892581.50 | ps/km |
| LP11 D1550 | 15.34 | ps/(nm · km) |
| LP11 MFD | 14.67 | μm |
| LP11 Aeff | 173.495 | μm² |
| DMD | 1.9 | ps/km |
| LP02 Cutoff | 1.2986 | μm |
| LP21 Cutoff | 1.2947 | μm |
| LP11 Cutoff | 2.0821 | μm |

### Example-9

In Example 9, the value of the first maximum refractive index (n1max) is 1.4481, the value of the second maximum refractive index (n2max) is 1.4481, the value of the third maximum refractive index (n3max) is 1.4457, the value of first radial thickness (d1) of the first up-doped region (106) is 1.09 μm, the value of the second radial thickness (d2) of the second up-doped region (108) is 5.155 μm and the value of the third radial thickness (d3) of the third up-doped region (110) is 2.95 μm. The few-mode optical fiber (100) thus obtained has the properties as mentioned in Table 9:

TABLE 9

| Parameter | Value | |
|---|---|---|
| LP01 GD | 4893337.10 | ps/km |
| LP01 D1550 | 21.1509 | ps/(nm · km) |
| LP01 MFD | 13.8634 | μm |
| LP01 Aeff | 163.61 | μm² |
| LP11 GD | 4893334.40 | ps/km |
| LP11 D1550 | 14.6248 | ps/(nm · km) |
| LP11 MFD | 14.2811 | μm |
| LP11 Aeff | 205.89 | μm² |
| DMD | 2.7 | ps/km |
| LP02 Cutoff | 1.2934 | μm |
| LP21 Cutoff | 1.2904 | μm |
| LP11 Cutoff | 2.0784 | μm |

### Example-10

In Example 10, the value of the first maximum refractive index (n1max) is 1.4455, the value of the second maximum refractive index (n2max) is 1.4482, the value of the third maximum refractive index (n3max) is 1.4457, the value of first radial thickness (d1) of the first up-doped region (106) is 1.02 μm, the value of the second radial thickness (d2) of the second up-doped region (108) is 5.179 μm and the value of the third radial thickness (d3) of the third up-doped region (110) is 2.95 μm. The few-mode optical fiber (100) thus obtained has the properties as mentioned in Table 10:

TABLE 10

| Parameter | Value | |
|---|---|---|
| LP01 GD | 4893712.9 | ps/km |
| LP01 D1550 | 21.1277 | ps/(nm · km) |
| LP01 MFD | 13.6931 | μm |
| LP01 Aeff | 159.97 | μm² |
| LP11 GD | 4893712 | ps/km |
| LP11 D1550 | 14.4575 | ps/(nm · km) |
| LP11 MFD | 14.115 | μm |
| LP11 Aeff | 200.86 | μm² |
| DMD | 0.7 | ps/km |
| LP02 Cutoff | 1.2993 | μm |
| LP21 Cutoff | 1.2949 | μm |
| LP11 Cutoff | 2.0866 | μm |

### Example-11

In Example 11, the value of the first maximum refractive index (n1max) is 1.4455, the value of the second maximum refractive index (n2max) is 1.448, the value of the third maximum refractive index (n3max) is 1.446, the value of first radial thickness (d1) of the first up-doped region (106) is 1 μm, the value of the second radial thickness (d2) of the second up-doped region (108) is 5.01 μm and the value of the third radial thickness (d3) of the third up-doped region (110) is 3 μm. The few-mode optical fiber (100) thus obtained has the properties as mentioned in Table 11:

TABLE 11

| Parameter | Value | |
|---|---|---|
| LP01 GD | 4892921.4 | ps/km |
| LP01 D1550 | 21.17 | ps/(nm · km) |
| LP01 MFD | 14.04 | μm |
| LP01 Aeff | 166.4 | μm² |
| LP11 GD | 4892761.5 | ps/km |
| LP11 D1550 | 15.04 | ps/(nm · km) |
| LP11 MFD | 14.6 | μm |
| LP11 Aeff | 212.6 | μm² |
| DMD | 159.9 | ps/km |
| LP02 Cutoff | 1.3 | μm |
| LP21 Cutoff | 1.29 | μm |
| LP11 Cutoff | 2.079 | μm |

### Example-12

In Example 12, the value of the first maximum refractive index (n1max) is 1.446, the value of the second maximum refractive index (n2max) is 1.448, the value of the third maximum refractive index (n3max) is 1.4465, the value of first radial thickness (d1) of the first up-doped region (106) is 0.99 μm, the value of the second radial thickness (d2) of the second up-doped region (108) is 4.7718 μm and the value of the third radial thickness (d3) of the third up-doped region (110) is 2.97 μm. The few-mode optical fiber (100) thus obtained has the properties as mentioned in Table 12:

TABLE 12

| Parameter | Value | |
|---|---|---|
| LP01 GD | 4892974.3 | ps/km |
| LP01 D1550 | 21.17 | ps/(nm · km) |
| LP01 Aeff | 169.1 | μm² |
| LP11 GD | 4893025.8 | ps/km |
| LP11 D1550 | 15.22 | ps/(nm · km) |
| LP11 Aeff | 212.6 | μm² |
| DMD | 51.4 | ps/km |
| LP02 Cutoff | 1.33 | μm |
| LP21 Cutoff | 1.32 | μm |
| LP11 Cutoff | 2.115 | μm |

In accordance with an embodiment of the present invention, it can be observed from the above examples that Examples 1 to 7, 9 and 10 that the present invention attains High Effective Area (Aeff) and Low Differential Mode Delay (DMD). In particular, the LP₀₁ mode of optical light propagates through the first effective area (LP₀₁ Aeff) which is greater than 150 μm², and the LP₁₁ mode of optical light propagates through has a second effective area (LP₁₁ Aeff) which is greater than 200 μm². Also, in all these cases, the DMD is less than 50 ps/km, and more particularly, less than 2.7 ps/km. Moreover, the bandwidth is greater than 100 GB. Further, it may be noted that in all these examples, the operating range is between 1.3 μm to 1.8 μm.

Advantageously, the few-mode optical fiber possesses high effective area and low Differential Mode Delay (DMD) that only allows LP₀₁ mode of optical light and LP₁₁ mode of optical light to propagate there-through. It has a large operating range for optical communication, typically in the range of 1300 nm to 1800 nm and a large bandwidth typically greater than 100 GB. In particular, the few-mode optical fiber has a large effective area, low nonlinear effects, such as self-phase modulation and four-wave mixing, are reduced. Moreover, the few-mode optical fiber has reduced nonlinear effects, signal distortion is reduced. Further, the few-mode optical fiber has a large effective area, the power density within the few-mode optical fiber is reduced. Since nonlinearities are reduced, it is possible to maintain better signal quality over long distances.

Yet another advantage of the invention is that since the few-mode optical fiber has low DMD, intermodal dispersion is low. Also, since the intermodal dispersion is low, signal overlap is reduced and data integrity is increased thus enabling high-speed, error-free communication is possible using the few-mode optical fiber.

A further it reduces the complexity of electronic circuits which are placed either at the source end and/or at the receiving end to cater to high DMD. For example, a less complicated equalizer circuit can be placed at the receiving end. By way of another example, a less complicated forward error correction circuit can be placed at the source end.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In a case that no conflict occurs, the embodiments in the present invention and the features in the embodiments may be mutually combined. The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An optical fiber (100) comprising:
at least three consecutive up-doped regions (102) such that each region is defined by a maximum refractive index value; and
a cladding region (104) surrounding the at least three consecutive up-doped regions (102),
wherein the optical fiber (100) enables propagation of exactly two modes.

2. The optical fiber (100) as claimed in claim 1, wherein the exactly two modes are a first linearly polarized mode of propagation of optical light (LP₀₁ mode), and a second linearly polarized mode of propagation of optical light (LP₁₁ mode),

3. The optical fiber (100) as claimed in claim 1, where the first linearly polarized mode (LP₀₁ mode) of propagation of optical light having a first mode field diameter (MFD1) in a range of 13.5 micrometer (μm) to 14.6 μm at 1550 nanometer (nm), and wherein the second linearly polarized mode (LP₁₁ mode) of propagation of optical light having a second mode field diameter (MFD2) in a range of 14 μm to 15 μm at 1550 nm.

4. The optical fiber (100) as claimed in claim 2, wherein the optical fiber (100) suppresses modes of propagation of optical light other than LP₀₁ mode and LP₁₁ mode through the optical fiber (100).

5. The optical fiber (100) as claimed in claim 1, wherein the cladding region (104) is free from down-dopants.

6. The optical fiber (100) as claimed in claim 1, wherein the at least three consecutive up-doped regions (102) are free from down-dopants.

7. The optical fiber (100) as claimed in claim 1, wherein the at least three consecutive up-doped regions (102) comprising a first up-doped region (106) having a first maximum refractive index value (n1max), a second up-doped region (108) having a second maximum refractive index value (n2max), and a third up-doped region (110) having a third maximum refractive index value (n3max), wherein n2max>n3max>n1max.

8. The optical fiber (100) as claimed in claim 1, wherein the first maximum refractive index value (n1max) being in a range of 1.4455 to 1.4481, the second maximum refractive index value (n2max) being in a range of 1.4478 to 1.4484, and the third maximum refractive index value (n3max) being in a range of 1.4453 to 1.4465.

9. The optical fiber (100) as claimed in claim 1, wherein the at least three consecutive up-doped regions (102) comprising the first up-doped region (106) having a first radius (130), the second up-doped region (108) having a second radius (132), and the third up-doped region (110) having a third radius (134), wherein the first radius (130) being smaller than the second radius (132), and the second radius (132) being greater than the third radius (134).

10. The optical fiber (100) as claimed in claim 9, wherein the first radius (130) of the first up-doped region (106) being in a range of 1.02 μm to 1.15 μm, the second radius (132) of the second up-doped region (108) being in a range of 5.9 μm to 6.4 μm, and the third radius (134) of the third up-doped region (110) being in a range of 8.8 μm to 9.5 μm.

11. The optical fiber (100) as claimed in claim 2, wherein the optical fiber (100) propagates the LP₀₁ mode of optical light through a first effective area (LP₀₁ Aeff) greater than or equal to 150 μm², wherein the LP₁₁ mode of optical light through a second effective area (LP₁₁ Aeff) greater than or equal to 200 μm².

12. The optical fiber (100) as claimed in claim 2, wherein the optical fiber (100) has a maximum differential mode delay (DMD) between the LP₀₁ mode of propagation of optical light and the LP₁₁ mode of propagation of optical light through being less than or equal to 50 picosecond/kilometer (ps/km) at a wavelength of 1550 nm.

13. The optical fiber (100) as claimed in claim 1, wherein a glass diameter (128) of the optical fiber (100) being greater than or equal to 80 μm and less than or equal to 130 μm.

14. The optical fiber (100) as claimed in claim 1, wherein a coating diameter of the optical fiber (100) with the coating layer (112) being in a range of 135 μm to 270 μm.

15. A few-mode optical fiber (100) comprising:
at least three concentric up-doped core regions (102); and
a pure silica cladding region (104) surrounding the at least three concentric up-doped core regions (102), wherein the few-mode optical (100) is entirely free of down-dopants, and wherein the few-mode optical fiber (100) supports propagation of only the LP₀₁ and LP₁₁ modes.

16. The few-mode optical fiber (100) of claim 15, wherein a first up-doped core region (106) of the at least three concentric up-doped core regions (102) has a maximum refractive index n₁ₘ_{^{ax}}, a second up-doped core region (108) has a maximum refractive index n₂ₘ_{^{ax}}>n₁ₘ_{^{ax}}, and a third up-doped core region (110) has a maximum refractive index n₃ₘ_{^{ax}}, wherein n₂ₘ_{^{ax}}>n₃ₘ_{^{ax}}>n₁ₘ_{^{ax}}.

17. The few-mode optical fiber (100) of claim 15, wherein the LP₀₁ mode has an effective area (Aeff)≥150 μm² and a mode field diameter (MFD) of 13.5-14.6 μm at 1550 nm, and the LP₁₁ mode has an Aeff≥200 μm² and an MFD of 14-15 μm at 1550 nm.

18. A few-mode optical fiber (100) comprising:
a first up-doped core region (106) with a refractive index n₁ₘ_{^{ax}},
a second up-doped core region (108) with a refractive index n₂ₘ_{^{ax}}>n₁ₘ_{^{ax}}, and a third up-doped core region (110) with a refractive index n₃ₘ_{^{ax}}, wherein n₂ₘ_{^{ax}}>n₃ₘ_{^{ax}}>n₁ₘ_{^{ax}}, and wherein the fiber supports only the LP₀₁ and LP₁₁ modes.

19. The few-mode optical fiber (100) of claim 18, wherein*the first up-doped core region (106) has a radius R₁ in the range of 1.02 μm to 1.15 μm, the second up-doped core region (108) has a radius R₂ in the range of 5.9 μm to 6.4 μm, and the third up-doped core region (110) has a radius R₃ in the range of 8.8 μm to 9.5 μm.

20. The few-mode optical fiber (100) of claim 18, wherein the differential mode delay (DMD) between LP₀₁ and LP₁₁ modes is ≤50 ps/km at 1550 nm, and the LP₁₁ mode has an effective area (Aeff)≥200 μm².
